(19) United States
(12) Patent Application Publication
(10) Pub. No.: US 2020/0264793 A1
(43) Pub. Date: Aug. 20, 2020

(54) METHOD TO CHANGE THE CAPACITY OF A STORAGE DEVICE

(71) Applicant: WALTON ADVANCED ENGINEERING INC., Kaohsiung (TW)

(72) Inventors: Hong Chi YU, Kaohsiung (TW); Mao Ting CHANG, Kaohsiung (TW)

(73) Assignee: WALTON ADVANCED ENGINEERING INC., Kaohsiung (TW)

(21) Appl. No.: 16/367,356

(22) Filed: Mar. 28, 2019

(30) Foreign Application Priority Data
Feb. 19, 2019 (TW) 108105489

(51) Int. Cl. G06F 3/06

(52) U.S. Cl. CPC G06F 3/0644; G06F 3/0623; G06F 3/067

(57) ABSTRACT

The present disclosure relates to a method to change the capacity of a storage device through which the capacity of an external storage device is increased as required without payment of extra charges in the beginning. In the method, a standard capacity sector only is accessed through a data access interface; then, an authorization code for dedicated unlock software is entered for electrical connection to an authorization module through a data access interface and one capacity expansion sector accessed based on the authorization code; finally, both a standard capacity sector and a capacity expansion sector are accessed through the data access interface.

### BACKGROUND OF THE INVENTION

### 1) Field of the Invention

The present disclosure relates to a method to change the capacity of a storage device wherein a capacity expansion sector is accessed assuredly based on an authorization code and a storage capacity is changeable through both the internet and a cloud storage space.

### 2) Description of the Prior Art

The local equipment short of the sufficient capacity should be provided with an internal storage device additionally or connected to an external storage device temporarily according to the prior art.

On the other hand, the cloud drive which came forward for users was still denounced because of the low network speed; the cloud applications generalized in recent years after popularization of the high-speed network have been available to enterprises but still subject to the network speed.

The patent documentations with respect to data storage are shown as follows:

U.S. patent Ser. No. 14/874,841 discloses a memory device with a changeable logic memory capacity and a system thereof in several embodiments. In an embodiment, a memory device comprises a plurality of memory blocks with which a physical memory capacity is defined collectively and a controller coupled with the plurality of memory blocks operatively. The controller, which is configured to broadcast a first logic memory capacity less than the physical memory capacity to a host device, is able to estimate at least one of the memory blocks at the end of service life immediately or almost to which a reply is made: (1) eliminate the at least one memory block or (2) truncate the host device's logic memory capacity which will be kept at a second logic memory capacity less than the fist logic memory capacity.

As shown in Japan Patent JP 2011-108899, a storage device comprises: drive circuits designed on a substrate; several storage cell arrays designed on and driven by the drive circuits wherein each of the storage cell arrays comprises multiple storage cells, each of which has first transistors with first gates covered on oxide semiconductor layers; capacity cells, each of which has a source electrode or a drain electrode, a first gate insulation layer and a conducting layer. Moreover, the multiple storage cell arrays overlap one another in arrangement. Accordingly, the storage device features a higher storage capacity per unit area for a longer data storage period.

R.O.C. Patent TW 1546729 discloses a data storage device and a method thereof. The data storage device comprises a physical storage block, an authentication unit with a unique ID and a control unit. The control unit, which is electrically connected to the physical storage block, receives the unique ID for creation of an authentication instruction by which an initial value and an available capacity for a logic block is created from the control unit. Then, a physical access block in the physical storage block is determined based on the initial value and the available capacity for the logic block wherein the initial value is a positive integral and the size of the physical access block is less than or equal to that of the physical storage block.

However, both value-added processing for corresponding data and possible capacity upgrade are still absent in the above patents. Against this background, a method to change the capacity of a storage device is provided in the present disclosure for settling the above problems.

### SUMMARY OF THE INVENTION

In view of the above problems, a method to change the capacity of a storage device provided in the present disclosure is based on an authorization code with which a storage space is checked and controlled by an authorization module.

A method to change the capacity of a storage device provided in the present disclosure can be applicable in paid-for storage spaces given to a payer.

A method to change the capacity of a storage device provided in the present disclosure makes an application mode flexible according to another requirement for a paid-for space as an added capacity.

A method to change the capacity of a storage device provided in the present disclosure contributes to lowered cost of sales with a product capacity planned and adjusted commercially.

A method to change the capacity of a storage device provided in the present disclosure coordinates with hardware compression for upgrade of data storage.

A method to change the capacity of a storage device provided in the present disclosure coordinates with the internet and the cloud hard disk for almost infinite expandability of storage capacities.

A method to change the capacity of a storage device provided in the present disclosure is characteristic of a capacity expansion sector that can be a cloud space buffer with almost infinite expandability in which local data is quickly saved for least restriction effectively.

To this end, a method to change the capacity of a storage device is embodied according to the following technical measures. A method to change the capacity of a storage device in the present disclosure comprises: step 1: a standard capacity sector only is accessed through a data access interface; step 2: an authorization code for dedicated unlock software is entered for electrical connection to an authorization module through a data access interface and one capacity expansion sector accessed based on the authorization code; step 3: both a standard capacity sector and a capacity expansion sector are accessed through the data access interface.

A method to change the capacity of a storage device is further embodied according to the following steps technically.

In the method to change the capacity of a storage device, the capacity expansion sector to be accessed in step 2 is a partial capacity.

In the method to change the capacity of a storage device, a hardware compression module is enabled assuredly based on the authorization code in step 2.

In the method to change the capacity of a storage device, the hardware compression module functions as each of image compression, disk compression and encryption compression or a combination thereof.

In the method to change the capacity of a storage device, both the standard capacity sector and the capacity expansion sector are accessed from the data access interface through the hardware compression module in step 3.

In the method to change the capacity of a storage device, a network interface coordinates with a collaborative cloud space sector in a server for accessing the capacity expansion sector after step 3.

In the method to change the capacity of a storage device, a telecommunications connection to the internet is completed at the network interface through mobile communications.

In the method to change the capacity of a storage device, the capacity expansion sector can be a cloud space buffer.

In contrast to the prior art, a method to change the capacity of a storage device in the present disclosure has some effects as follows: (1) a paid-for storage space provided correspondingly; (2) a flexible application mode according to a requirement for a paid-for space as an added capacity; (3) lowered cost of sales according to a product capacity planned and adjusted commercially; (4) a capacity expansion sector as the cloud space buffer with almost infinite expandability in which local data is quickly saved for least restriction effectively.

### BRIEF DESCRIPTIONS OF THE DRAWINGS

FIG. 1a is the first flowchart for a method to change the capacity of a storage device in the first embodiment;

FIG. 1b is the second flowchart for a method to change the capacity of a storage device in the first embodiment;

FIG. 2 is the flowchart for a method to change the capacity of a storage device in the second embodiment;

FIG. 3a is the first schematic view of a method to change the capacity of a storage device in a preferred embodiment;

FIG. 3b is the second schematic view of a method to change the capacity of a storage device in a preferred embodiment;

FIG. 3c is the third schematic view of a method to change the capacity of a storage device in a preferred embodiment;

FIG. 3d is the fourth schematic view of a method to change the capacity of a storage device in a preferred embodiment;

FIG. 3e is the fifth schematic view of a method to change the capacity of a storage device in a preferred embodiment.

### DETAILED DESCRIPTIONS OF THE PREFERRED EMBODIMENTS

A method to change the capacity of a storage device is explained in the preferred embodiment for clear understanding of purposes, characteristics and effects of the present disclosure.

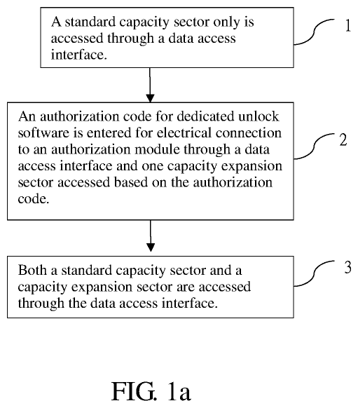

Referring to the first embodiment in FIG. 1a, which illustrates a method to change the capacity of a storage device comprises step 1 (1), step 2 (2) and step 3 (3).

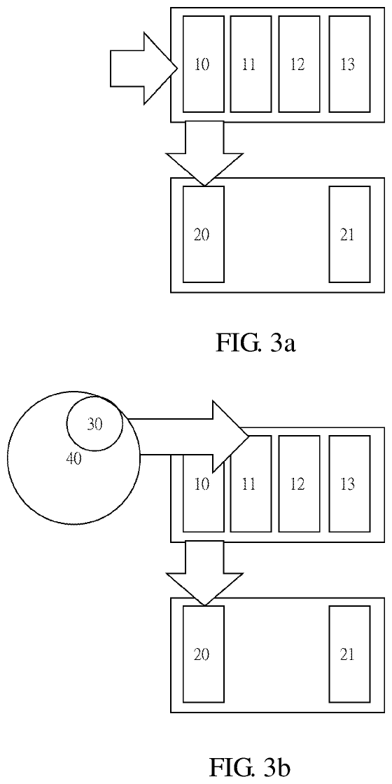

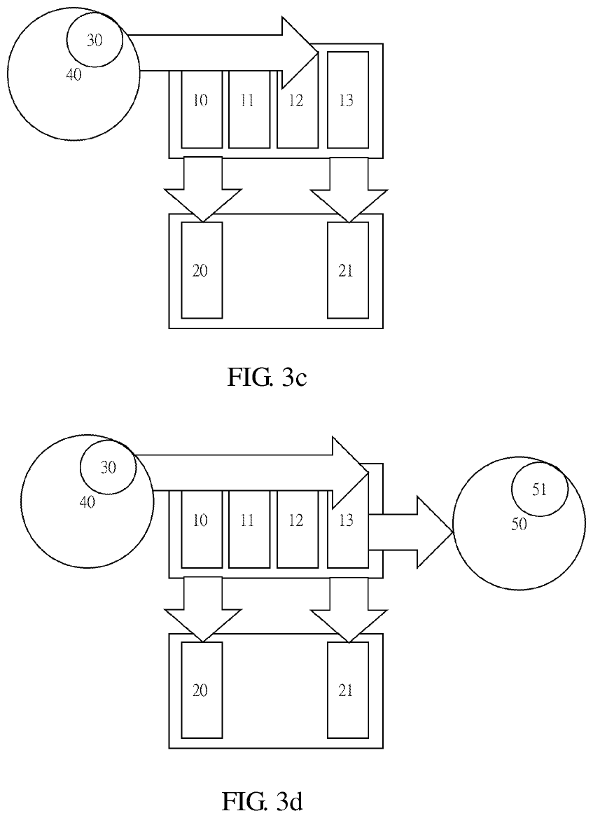

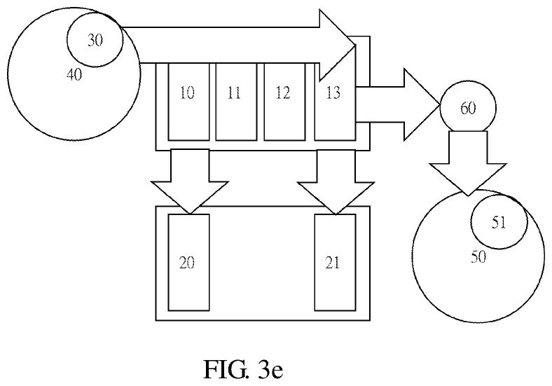

Referring to FIG. 1a for step 1 (1) and FIG. 3a, which illustrate a standard capacity sector (20) is accessed through a data access interface (10) in step 1 (1).

In general, the data access interface (10) is defined to be a wired interface, i.e., a common USB (Universal Serial Bus) interface, or a wireless interface, i.e., a mainstream wireless network interface, through which an electric connectivity, wired or wireless, is completed, a storage device is accessed or electric power is supplied; furthermore, the standard capacity sector (20) is a storage space of an external storage device in which a user's digital data is saved.

Moreover, referring to FIG. 1a for step 2 (2) and FIG. 3b, which illustrate an authorization code (30) is entered from dedicated unlock software (40) and an electric connection to an authorization module (11) is created through the data access interface (10) such that one capacity expansion sector (21) is accessed assuredly based on the authorization code (30) in step 2 (2).

Specifically, the authorization code (30) for information like capacity, function and cloud account is a serial number not indicated in plain texts and proves effective in ensuring a capacity, functions and a cloud account available to a user; moreover, the dedicated unlock software (40) is an application program installed in an appliance, for example, a computer or a mobile device, and enabled to read information in the authorization code (30) and transit the authorization code (30) to the authorization module (11).

Furthermore, the authorization module (11) is a controller inside a storage device for accessing data in the standard capacity sector (20) through the data access interface (10), as shown in step 1 (1). When the authorization code (30) is entered from the dedicated unlock software (40) for electrical connection to the authorization module (11) through the data access interface (10), some corresponding information like capacity, function and cloud account is available to a user from the authorization module (11).

Preferably, the capacity expansion sector (21) is a partial capacity to be accessed through the authorization code (30) but another changeable partial capacity can be partitioned to the capacity expansion sector (21) based on commercial operation; moreover, as shown in FIG. 1b, step 2 (2) is additionally followed by step 2a (2a), which ensures a hardware compression module (12) is enabled through the authorization code (30) wherein the hardware compression module (12) functions as each of image compression, disk compression and encryption compression or a combination thereof such that digital data in a storage device to be accessed from the data access interface (10) by a user is compressed by the hardware compression module (12).

Finally, referring to FIG. 1a for step 3 (3) and FIG. 3c, which illustrate the standard capacity sector (20) and the capacity expansion sector (21) are accessed through the data access interface (10) in step 3 (3).

Accordingly, both the standard capacity sector (20) and the capacity expansion sector (21) are accessed by a user through the data access interface (10) directly.

Preferably, the standard capacity sector (20) and the capacity expansion sector (21) are accessed from the data access interface (10) through the hardware compression module (12) in step 3 (3) after addition of step 2a (2a) as mentioned previously wherein the hardware compression module (12) functions as each of image compression, disk compression and encryption compression or a combination thereof such that digital data in a storage device to be accessed from the data access interface (10) by a user is compressed by the hardware compression module (12).

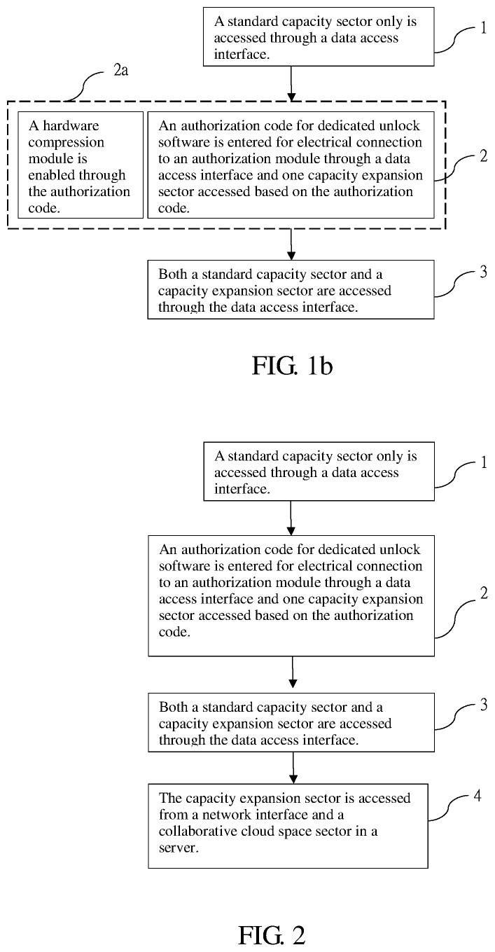

Referring to FIG. 2, which illustrates a method to change the capacity of a storage device in the second embodiment in which the characteristics identical to those of the first embodiment in FIGS. 1a and 1b are not explained hereinafter. The difference in the second embodiment differing from the first embodiment is step 4 (4) after step 3 (3).

Referring to FIG. 2 for the second embodiment, which illustrates a method to change the capacity of a storage device comprises step 1 (1), step 2 (2), step 3 (3) and step 4 (4).

Referring to FIG. 1a for step 1 (1) and FIG. 3a, which illustrate a standard capacity sector (20) only is accessed through a data access interface (10) in step 1 (1).

Then, referring to FIG. 2 for step 2 (2) and FIG. 3b, which illustrate an authorization code (30) is entered from dedicated unlock software (40) and an electric connection to an authorization module (11) is created through the data access interface (10) such that one capacity expansion sector (21) is accessed assuredly based on the authorization code (30) in step 2 (2).

Furthermore, referring to FIG. 2 for step 3 (3) and FIG. 3c, which illustrate the standard capacity sector (20) and the capacity expansion sector (21) are accessed through the data access interface (10) in step 3 (3).

Finally, referring to FIG. 2 for step 4 (4) and FIG. 3d, which illustrate the capacity expansion sector (21) is accessed from a network interface (13) and a collaborative cloud space sector (51) in a server (50) in step 4 (4).

Specifically, the network interface (13) can be embedded in an external storage device and used to link an external network independently; moreover, the network interface (13) is available to network applications through an application program installed in an appliance which is connected to the internet; the server (50) is an electric appliance being available to an internet connection and electrically connected to a device with which a method to change the capacity of a storage device is executed for availability of authentication and specific storage services; the cloud space sector (51) which is prepared in the server (50) for storage of digital data works with the capacity expansion sector (21) herein.

Preferably, as shown in FIG. 3e, the network interface (13) is designed for a telecommunications link through mobile communications (60) which is based on the 3rd-generation mobile phone mobile communication technology standards and following technologies. Accordingly, a storage device in the present disclosure should be provided with a Subscriber Identity Module (SIM) for authentication through the mobile communications (60); the storage device continuously coordinates with the collaborative cloud space sector (51) in the server (50) after step 4 (4) and runs according to electricity from an external power supply or batteries. Furthermore, the capacity expansion sector (21) can be a cloud space buffer from which active records are cached but the cloud space sector (51) provides almost infinite expandability for inactive records.

For easy understanding of the present disclosure, the practical process to execute a method to change the capacity of a storage device is shown as follows:

As shown in FIG. 3a, a standard capacity sector (20) is accessed by a user through a data access interface (10) which can be either a wired USB (Universal Serial Bus) interface for an electric connection and supply of electric power or a WIFI interface for an electric connection based on additional batteries or an external power supply and access to the standard capacity sector (20) from outside.

Then, as shown in FIGS. 3b and 3c, an authorization code (30) is entered in a device in which dedicated unlock software (40) is installed for an electric connection to an authorization module (11) through the data access interface (10) such that some information like available capacity, function and cloud account corresponding to the authorization code (30) is verified by the authorization module (11). Accordingly, an available capacity in a capacity expansion sector (21) is accessed; meanwhile, the hardware compression module (12) functions as image compression, disk compression or encryption compression and a collaborative cloud space sector (51) in a server (50) is enabled correspondingly.

Then, as shown in FIG. 3e, the capacity expansion sector (21) is accessed from the network interface (13) and the collaborative cloud space sector (51) in the server (50) from which a telecommunications connection to the internet is completed through the mobile communications (60) indirectly.

Digital data which has been written in the capacity expansion sector (21) through the data access interface (10) will be compressed by the hardware compression module (12) and transmitted to the cloud space sector (51) from the network interface (13) through the mobile communications (60); furthermore, the capacity expansion sector (21) can be a cloud space buffer from which active records are cached but the cloud space sector (51) provides almost infinite expandability for inactive records.

Then, digital data can be delivered to the cloud space sector (51) from the network interface (13) through the mobile communications (60) with electricity of batteries supporter by an external power supply provided to a storage device for running.

Both the standard capacity sector (20) and the capacity expansion sector (21) can be accessed through the data access interface (10).

Accordingly, a method to change the capacity of a storage device which is different from an ordinary method for the adjustable capacity of a storage device and referred to as creative work in applications of a storage device meets patentability and is applied for the patent.

It should be reiterated that the above descriptions present the preferred embodiments, and any equivalent changes in specifications, claims or drawings still belongs to the technical field within the present disclosure with reference to claims hereinafter.

What is claimed is:

1. A method to change the capacity of a storage device, comprising:
step 1: A standard capacity sector only is accessed through a data access interface;
step 2: an authorization code for dedicated unlock software is entered for electrical connection to an authorization module through a data access interface and one capacity expansion sector accessed based on the authorization code;
step 3: both a standard capacity sector and a capacity expansion sector are accessed through the data access interface.

2. The method to change the capacity of a storage device as claimed in claim 1 wherein the capacity expansion sector to be accessed in step 2 is a partial capacity.

3. The method to change the capacity of a storage device as claimed in claim 1 wherein a hardware compression module is enabled assuredly based on the authorization code in step 2.

4. The method to change the capacity of a storage device as claimed in claim 3 wherein the hardware compression module functions as each of image compression, disk compression and encryption compression or a combination thereof.

5. The method to change the capacity of a storage device as claimed in claim 3 wherein both the standard capacity sector and the capacity expansion sector are accessed from the data access interface through the hardware compression module in step 3.

6. The method to change the capacity of a storage device as claimed in claim 1 wherein a network interface coordinates with a collaborative cloud space sector in a server for accessing the capacity expansion sector after step 3.

7. The method to change the capacity of a storage device as claimed in claim 6 wherein a telecommunications connection to the internet is completed at the network interface through mobile communications.

8. The method to change the capacity of a storage device as claimed in claim 6 wherein the capacity expansion sector can be a cloud space buffer.
